(19) United States
(12) Patent Application Publication
(10) Pub. No.: US 2007/0144687 A1
(43) Pub. Date: Jun. 28, 2007

(54) Segmented door

(76) Inventor: Edgar Griebel, Wurzburg (DE)

Correspondence Address: EDWIN D. SCHINDLER, FIVE HIRSCH AVENUE, P.O. BOX 966, CORAM, NY, 11727-0966, US

(21) Appl. No.: 11/319,040

(22) Filed: Dec. 27, 2005

(51) Int. Cl. E05D 15/00

(52) U.S. Cl. 160/201

(57) ABSTRACT

A segmented door for installation in door openings of garages and buildings, includes a plurality a plurality of crosswise, vertically displaceable transverse door segments, which are foldably connected to one another and have, at their ends, one or more rollers, which are guided in one or more tracks, along with a drive axle, which is connected to a drive and traction cables for raising and lowering the segmented door. In a curvature region of the tracks, either a crank arm is provided on the drive axle or a spring, or other elastic device, is provided on the traction cables for length compensation of the traction cables during inclination of the door segments.

### BACKGROUND OF THE INVENTION

1. Technical Field of the Invention

The present invention relates to a segmented door for installation in door openings of garages and buildings, comprising a plurality of crosswise, vertically displaceable door segments, which are foldably connected to one another and have at their ends one or more rollers, which are guided in one or more runners, and a drive axle, which is connected to a drive and traction cables, for raising and lowering the segmented door.

2. Description of the Prior Art

Segmented doors generally consist of a plurality of crosswise door sections that are pivotably connected to one another, at least in sections, along their longitudinal edges. They are guided by means of one or more rollers on both end faces of each segment, in runners that are fastened to the building in the region of the door opening. In the lintel region of the door opening, the runners curve and run along the room ceiling in the vertical direction.

The term “lintel region” is used for the region immediately behind the top edge of a door opening. If the top edge of the door opening is lowered well below the level of the room ceiling, then a spacious lintel region is present. A spacious lintel region permits the accommodation of a drive below the door opening and a larger radius of curvature of the runners, while in the case of door openings with a low lintel the drive usually lies at that end of the room that lies opposite the door opening. If the runners have too small a radius then, disadvantageously, self-jamming of the door sections rapidly occurs.

In particular, prefabricated garages, which are often equipped with folding doors during manufacturing, often have a very small lintel region, so that disadvantageously retrofitting of a conventional segmented door for these garages does not come into consideration.

In the prior art, segmented doors are known that can be opened by means of a torsion spring as compensation for the door weight. For this purpose, the ends of a drive axle, which is assisted in its rotation by means of a torsion spring, is connected by means of traction cables to the end faces of one of the lower door segments. If, for reasons of space, the drive axle is positioned, not in the lintel region, but in the rearward region of the garage, the traction cables are deflected in the lintel region.

### SUMMARY OF THE INVENTION

Against this background, the object of the invention is the modulation and improvement of the force transmission imparted by the traction cable by ensuring longitudinal compensation of the traction cable during the inclination of the door segments in the curvature region of the runners.

To achieve this object, the invention provides a segmented door, which is characterized in that, in the curvature region of the runners, devices are provided on the drive axle and/or elastic means are provided on the traction cables for length compensation of the traction cables during inclination of the door segments.

The gist of the invention concerns including a sinusoidally alternating length compensation of the traction cables while the traction cables are continually under particular tension during inclination of the door segments in the curvature region of the door opening; in the curvature region of the runners, an additional tension is exerted on the cable because of the geometrical change, which is associated with the inclination of the door segments. This tension is at a maximum when the individual segments have a 45° position. The elastic elements that belong to the drive axle or are fastened on the drive axle and/or integrated into the traction cable permit a smoother guidance of the door segments through the curvature region of the runners and prevent jamming of the door segments and cable breakages. This effect can be reinforced if additional deflecting rollers provided for guidance of the traction cables are resiliently mounted.

The drive axle is connected, so as to be non-rotatable, at its end to toothed wheels and/or chain wheels, which engage in chains or toothed belts that are installed in parallel with the runners and guides the rolling movement of the drive axle on these chains or toothed belt for movement of the door segment.

As devices for length compensation of the traction cables, it is provided that the drive axle is designed as a crank, the traction cables being fastenable in the crank region of the rotating drive axle. Alternatively, for example, it is conceivable to fasten the crank arms at the end of a continuously cylindrical drive axle. The traction cables are fastened so as to be rotatable on the outside of the crank elements and can thereby rotate freely with the drive axle that is moving on the toothed chains.

Of course, the design of the crank axle and/or the length of the crank arms that is fastened on the drive axle is dependent on the respective height of the door segments. The height of the door sections influences the radius of curvature of the runners in exactly the same way. In the segmented door according to the invention, starting from the height of the door segments, the crank axle or crank arms and the radius of curvature of the runners must be matched to one another.

Besides the fastening of the traction cables to a crank axle or to the crank arms, which are connected to a cylindrical axle, the integration of elastic elements into the traction cables is provided for. As elastic elements, for example, metal helical springs or rubber-like elements come into consideration. The elastic elements can either serve as a link between the traction cable and one of the components of the segmented door or can be integrated into the traction cable at any desired point.

### DESCRIPTION OF THE PREFERRED EMBODIMENTS

In a further development of the invention, the use of flange elements is provided for. The drive axles pass through the flange elements at their ends, for which purpose the latter have in each case an opening, in which the drive axle is rotatably mounted. The attachment of the cable ends takes place at additional openings provided for this purpose in the flange element.

When a flange element is used, it is conceivable that the torsion spring that is positioned on the drive axle is connected at one end to the drive axle and at the other end to the flange element.

In a particularly preferred embodiment, the uppermost door section is preferably connected directly via the bolts of the rollers, directly and rotatably to the flange element.

To reinforce the effect of the smooth cable guidance, it is additionally provided that, in particular, the deflecting roller positioned in the lintel region of the door opening is resiliently mounted during the inclination of the door segments. The running of the individual door segments in the curvature region of the runners is, because of the resiliently mounted deflecting rollers, jam-free and smooth. The pushing action that is applied by the lowermost door segment on the door segments above additionally facilitates the opening of the door. In principle, it is conceivable to spring mount each deflection roller, over which one of the traction cables is guided. For spring mounting of the deflec-tion pulleys, helical compression springs are provided, which are mounted on the axle or suspension of the movably mounted deflection roller such that the cable tension is increased by the influence of the helical compression springs. By means of an appropriate installation, however, it is also conceivable to use helical tension springs or any other type of spring that can be used for the above-described purpose.

The fastening of the traction cable to one of the lowermost door sections or the deflection of the traction cable around a deflection roll fastened on the lowermost door segment permits the exertion of a pushing effect, which, together with the traction effect acting on the uppermost door segment, permits a jam-free transport of the individual door sections in particular in the curvature region of the runners.

The interruption of the traction cable by means of elastic elements preferably takes place in the vertically extending region on the inside of the segmented door. In principle, the installation of the spring in the cable is naturally conceivable at a wide variety of points in so far as the spring, during movement of the cable, has a sufficient distance from the respective nearest deflection roller.

The strength of the springs used should be dimensioned such that each traction cable has the necessary tension for lifting the door segments, but at the same time the necessary spring travel for length-compensation of the traction cable is present when the door segments are in an oblique position in the curvature region of the runners.

It is provided that the drive axle has at its ends, in addition to the toothed wheels or chain wheels, additional rollers, which are guided in the runners. By this means, the chain wheels are prevented from jumping out of the chains or toothed belts. If the drive axle does not have rollers at its end, it is conceivable that guide rails lie against the top side of the drive axle at both sides, which also prevent the toothed wheels or chain wheels from jumping out of the toothed belts or chain belts. The rollers are guided in runners, which have a U-profile in cross-section. The runners have a region extending in the vertical and horizontal direction, which is connected by the curvature region in the lintel region of the door. The insides of the runners, on which the rollers lie, are adapted for better guidance of the preferably rounded outer shape of the rollers.

It goes without saying, that the width and/or height of the door sections depends on the radius of curvature of the runners in the lintel region of the door opening. It is pro-vided that the curvature of the runners can be adapted and, to this end, the runners can be exchanged in the curvature region. The mounting of the runners thus corresponds to a modular assembly of the individual runner regions.

To assist the torsional spring, which is adapted to the weight of the individual door segments, the installation of an electric motor is provided for in the region of the drive axle. It is conceivable that the drive of a motor aligned parallel to the drive axle is fric-tionally connected to the drive axle of the segmented door. In this case, it may be a wind-screen wiper motor that can be operated with a 24-volt power supply. With the use of such a motor, the automatic opening of the segmented door is conceivable even for garages that do not have an electrical connection. The charging of the battery provided for energy supply of the motor can take place externally or by means of one or more solar modules installed on one of the door segments. The solar modules are preferably mounted on one of the upper door segments because the solar module is better protected in this region. Damage is conceivable, for example, by means of the bumper of a car driven too close to the segmented door.

It is provided that the electrical circuit included in the solar modules and battery has an integrated charge controller.

### BRIEF DESCRIPTION OF THE DRAWING FIGURES

Further details and features of the invention are explained below in greater detail with reference to examples. The illustrated examples are not intended to restrict the invention, but only to explain it. In schematic view:

FIG. 1 shows a traction cable fastening on the flange element and crank arm;

FIG. 2 shows a traction cable fastening only on the flange element;

FIG. 3 shows a cross-section through the segmented door with an inclined segment in the lintel region;

FIG. 4 shows the drive axle with electric motor; and,

FIG. 5 shows the segmented door with solar modules in top view.

### DETAILED DESCRIPTION OF THE DRAWING FIGURES

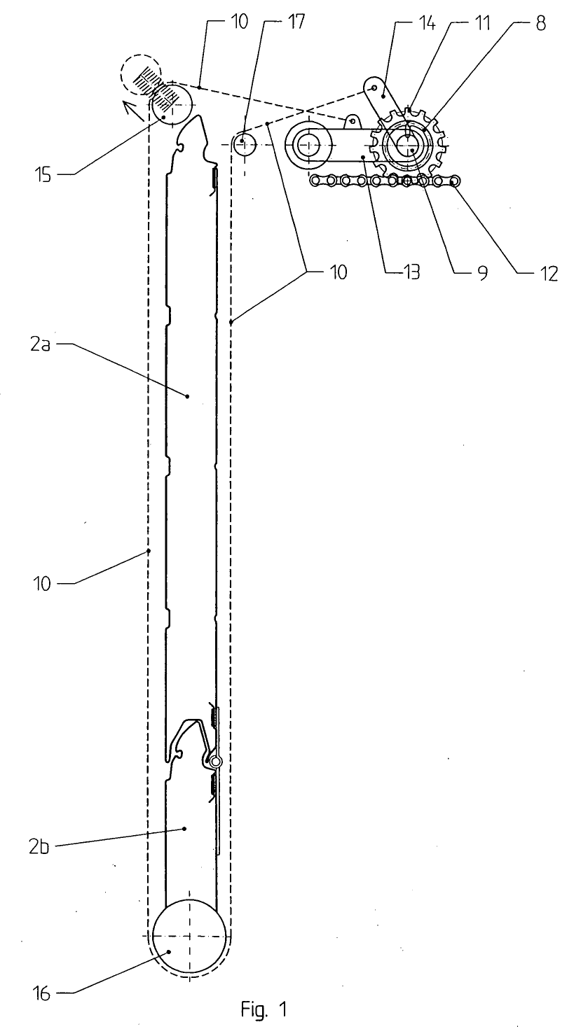

FIG. 1 shows, in side view, the fastening of a traction cable 10 on the flange element 13 and lever arm 14. That part of the flange element 13 that faces towards the door section 2 is connected to the roller 3 of the uppermost door segment 2a. From flange part 13, a traction cable 10 proceeds, which is guided via the deflection roller 15 in the lintel region, in the vertical direction, via the deflection roller 16 in the lower region of the segmented door, via a third deflection roller 17 back to a second mount, which is provided for this purpose on the crank arm 14. The tension movement that is transmitted to the traction cable by the crank arm 14 is modulated as a function of the length of the crank arm. With each rounding of a curve by a segment in the curvature region of the runners, the traction cable changes its length. The modulation emanating from the crank arm effects the necessary length compensation and thus leads to a smoother travel of the door segment 2 through the curvature region of the runners 5.

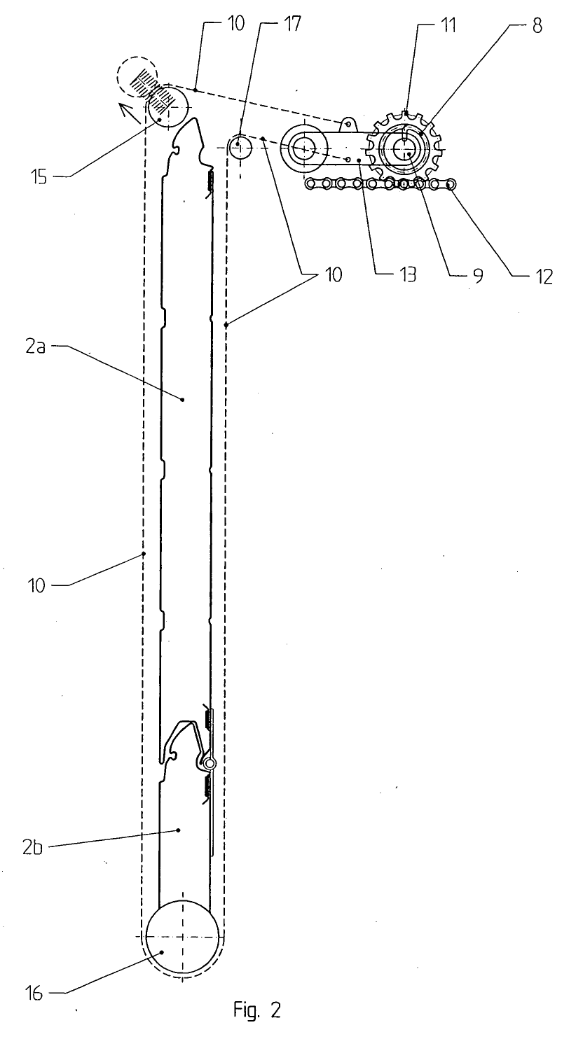

FIG. 2 shows a side view of a traction cable 10, which is fastened at both ends on the flange element 13. The flange element 13 is moreover connect to the roller of the uppermost door segment 2a. Starting from a corresponding opening in the flange element 13, the traction cable 10 passes via the deflection roller 15 in the lintel region in the vertical direction, via the deflection roller 16 in the lower region of the segmented door, via a third deflection roller 17, back to a second opening provided for this purpose in flange part 13. With each rounding of a curve by a segment in the curvature region of the runners, the traction cable changes its length. To compensate for this lengthening, in the illustrated example the deflection roller 15 is movably mounted in the lintel region. To maintain the tension in the traction cable, the deflection roller 15 bears against the traction cable by spring pressure.

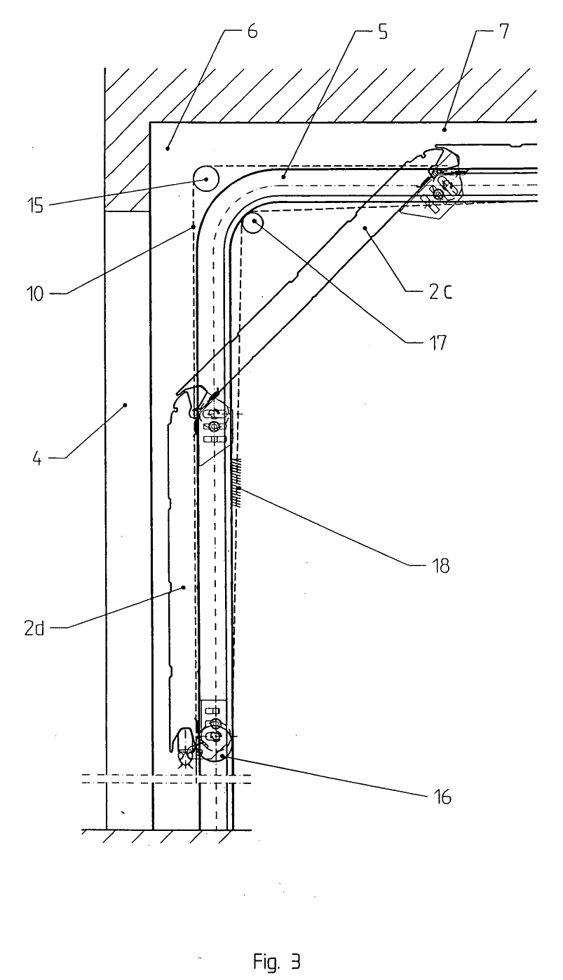

FIG. 3 shows the cross-section through the segmented door 1, which in the lintel region 6 is deflected via the deflection roller 15 and, at the end of the segmented door 1, via the segmented roller 16. On the inside of the segmented door 1, the traction cable 10 is interrupted by an elastic element (spring) 18. The springs 18 ensure the length compen-sation of the traction cable 10, with the door segments 2 in an inclined position, in the lintel region 6 of the door opening 4.

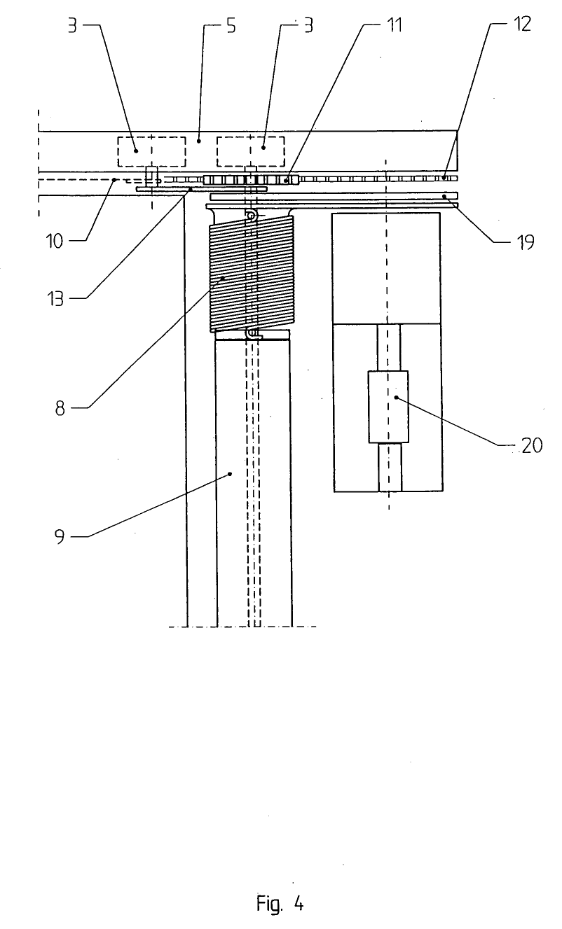

FIG. 4 shows a top view of the drive axle 9 with the torsion spring 8. The rotatably mounted ends of the drive axle 9 are, in the illustrated example, connected to the drive 9 of an electric motor 20. The motor 20 allows opening of the door without the use of muscle power, by remote control if necessary. Since the principal weight of the door segments 2 are received by the torsion springs 8, the motor 20 is only used for assisting the movement of the segmented door, and the motor power can therefore be dimensioned with a comparatively low value. The drive of the motor 20 can be carried out by means of a rechargeable storage battery. FIG. 4 also shows that, on the ends of the drive axle 9, besides the toothed wheels 11, rollers 3 are provided, which are guided in the runners 5. The teeth of the toothed wheels 11 engage frictionally in the openings of the chains or toothed belts 12. In the illustrated example, the traction cable 10 does not proceed from the flange part 13, but from the axle of the roller 3. The axle of the roller 3 extends through an opening in the flange part 13, which is movably connected to the drive axle 9.

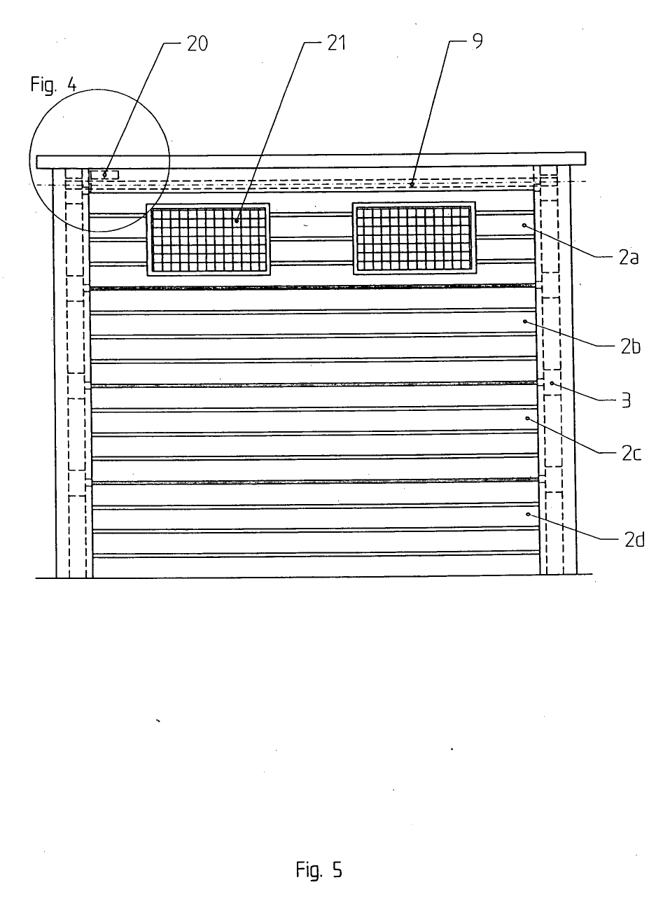

FIG. 5 shows the segmented door with the solar modules 21 fastened to the outside of the uppermost door segment 2a. The solar modules 21 serve for charging the storage battery, which is provided for driving the electric motor 20.

### List of Reference Characters

1 Segmented door
2 Door segments
3 Rollers
4 Door opening
5 Runners
6 Lintel region in door opening
7 Building ceiling
8 Torsion springs
9 Drive axle
10 Traction cable
11 Chain wheel
12 Chains or toothed belts
13 Flange element
14 Crank arm on the drive axle
15 Deflection roller in the lintel region
16 Deflection roller on one of the lower door segments
17 Deflection roller in the lintel region on the inside of the segmented door
18 Helical spring in the traction cable
19 Drive of an electric motor
20 Electric motor
21 Solar modules

What is claimed is:

1-24. (canceled)

25. A segmented door for installation in door openings of garages and buildings, comprising:
a plurality of crosswise, vertically displaceable door segments foldably connected to one another;
at least one roller at each end of said vertically displaceable door segments, said at least one roller being guidable in tracks;
a drive;
traction cables;
a crank arm; and,
a drive axle connected to said drive and said traction cables, for raising and lowering said segmented door, wherein for length compensation of said traction cables during inclination of said vertically displaceable door segments in a curvature region of the tracks, said crank arm is provided on said drive axle.

26. The segmented door for installation in door openings of garages and buildings according to claim 25, wherein said drive axle is non-rotatably connected to end sections of a wheel that engages chains or toothed belts running along a ceiling in a direction of the tracks.

27. The segmented door for installation in door openings of garages and buildings according to claim 26, wherein said wheel is a toothed wheel.

28. The segmented door for installation in door openings of garages and buildings according to claim 26, wherein said wheel is a chain wheel.

29. The segmented door for installation in door openings of garages and buildings according to claim 25, wherein said drive axle is a crank axle at, at least, one point of said drive axle, said traction cables being connected to lower portions of said door segments and also being connected at one end to elements of said drive axle having a crank action.

30. The segmented door for installation in door openings of garages and buildings according to claim 25, wherein said crank arm is a lever arm acting as a crank at ends of said drive axle, said traction cables being connected to lower portions of said door segments and also being connected at one end to elements of said drive axle having a crank action.

31. The segmented door for installation in door openings of garages and buildings according to claim 25, further comprising a flange element mounted on said drive axle, said flange element having openings for fastening said traction cables or an uppermost portion of said vertically, displaceable door segments.

32. The segmented door for installation in door openings of garages and buildings according to claim 25, wherein said vertically, displaceable door segments have an uppermost portion that is rotatably connected to said drive axle.

33. The segmented door for installation in door openings of garages and buildings according to claim 25, wherein said tracks have a U-shaped profile and said at least one roller of said vertically displaceable door segments are guided by inner sides of both flanks of said U-shaped profile.

34. The segmented door for installation in door openings of garages and buildings according to claim 25, wherein said tracks for guiding at least one said roller run vertically in one region of a door opening and run in a curved path in an lintel region of the door opening.

35. A segmented door for installation in door openings of garages and buildings, comprising:
a plurality of crosswise, vertically displaceable door segments foldably connected to one another;
at least one roller at each end of said vertically displaceable door segments, said at least one roller being guidable in tracks;
a drive;
traction cables provided with means for providing elasticity to said traction cables; and,
a drive axle connected to said drive and said traction cables, for raising and lowering said segmented door, wherein for length compensation of said traction cables during inclination of said vertically displaceable door segments in a curvature region of the tracks.

36. The segmented door for installation in door openings of garages and buildings according to claim 35, wherein said drive axle is non-rotatably connected to end sections of a wheel that engages chains or toothed belts running along a ceiling in a direction of the tracks.

37. The segmented door for installation in door openings of garages and buildings according to claim 36, wherein said wheel is a toothed wheel.

38. The segmented door for installation in door openings of garages and buildings according to claim 36, wherein said wheel is a chain wheel.

39. The segmented door for installation in door openings of garages and buildings according to claim 35, wherein said drive axle is a crank axle at, at least, one point of said drive axle, said traction cables being connected to lower portions of said door segments and also being connected at one end to elements of said drive axle having a crank action.

40. The segmented door for installation in door openings of garages and buildings according to claim 35, wherein said means for providing elasticity to said traction cables is integrated into said traction cables.

41. The segmented door for installation in door openings of garages and buildings according to claim 35, wherein said traction cables is connected at, at least, one end of said traction cables, via said means for providing elasticity to said traction cables, to said drive axle or to a lower door segment of said vertically displaceable door segments.

42. The segmented door for installation in door openings of garages and buildings according to claim 35, wherein said means for providing elasticity to said traction cables include a plurality of helical springs.

43. The segmented door for installation in door openings of garages and buildings according to claim 35, wherein said vertically, displaceable door segments have an uppermost portion that is rotatably connected to said drive axle.

44. The segmented door for installation in door openings of garages and buildings according to claim 35, wherein said tracks for guiding at least one said roller run vertically in one region of a door opening and run in a curved path in an lintel region of the door opening.
